(19) United States
(12) Patent Application Publication
(10) Pub. No.: US 2023/0089868 A1
(43) Pub. Date: Mar. 23, 2023

(54) LIGHTING CONTROL DEVICE AND LIGHTING CONTROL SYSTEM

(71) Applicant: Panasonic Intellectual Property Management Co., Ltd., Osaka (JP)

(72) Inventors: Kentaro UEDA, Osaka (JP); Shinichi MURAKAMI, Osaka (JP); Yohei HAYASHI, Shiga (JP)

(21) Appl. No.: 17/798,279

(22) PCT Filed: Feb. 22, 2021
(86) PCT No.: PCT/JP2021/006652

§ 371 Date: Aug. 8, 2022

(30) Foreign Application Priority Data
Feb. 26, 2020 (JP) 2020-030226

(51) Int. Cl. H05B 47/18

(52) U.S. Cl. CPC H05B 47/18

(57) ABSTRACT

A lighting control device that controls lighting fixtures includes: a command generator that generates one or more commands for controlling the lighting fixtures; a signal transceiver that communicates with the lighting fixtures; and a communication protocol setter that sets which one of two or more types of communication protocols is to be used. The two or more types of communication protocols include a first communication protocol. The signal transceiver simultaneously transmits, using the first communication protocol, a first command to each of the lighting fixtures. The first command is included in the one or more commands and requests a response. The communication protocol setter sets the first communication protocol as the communication protocol to be used for one or more of the lighting fixtures that have responded to the first command.

### CROSS-REFERENCE OF RELATED APPLICATIONS

This application is the U.S. National Phase under 35 U.S.C. § 371 of International Patent Application No. PCT/JP2021/006652, filed on Feb. 22, 2021, which in turn claims the benefit of Japanese Patent Application No. 2020-030226, filed on Feb. 26, 2020, the entire disclosures of which Applications are incorporated by reference herein.

### TECHNICAL FIELD

The present invention relates to a lighting control device and a lighting control system.

### BACKGROUND ART

Conventionally, when lighting fixtures are provided, a lighting administrator has needed to manually set a type of protocol for controlling each of the lighting fixtures for a lighting control device. Patent Literature (PTL) 1 discloses an invention of a lighting control device and a lighting system that support two communication protocols.

### CITATION LIST

### Patent Literature

[PTL 1] Japanese Unexamined Patent Application Publication No. 2018-152274

### SUMMARY OF INVENTION

### Technical Problem

However, the lighting control device and so on disclosed in PTL 1 can only identify two communication protocols, and one of the two supported communication protocols is for one-way communication.

Therefore, if the communication protocol of the one-way communication is used, the lighting control device and so on cannot receive a response from a lighting fixture.

In view of the above, the present invention provides a lighting control device and so on that can identify communication protocols even when two or more communication protocols are used in lighting fixtures.

### Solution to Problem

A lighting control device according to one aspect of the present invention is a lighting control device that controls a plurality of lighting fixtures. The lighting control device includes: a command generator that generates one or more commands for controlling the plurality of lighting fixtures; a signal transceiver that communicates with the plurality of lighting fixtures; and a communication protocol setter that sets which one of two or more types of communication protocols is to be used, the two or more types of communication protocols including a first communication protocol. The signal transceiver simultaneously transmits, using the first communication protocol, a first command to each of the plurality of lighting fixtures, the first command being included in the one or more commands and requesting a response, and the communication protocol setter sets the first communication protocol as the communication protocol to be used for one or more of the plurality of lighting fixtures that have responded to the first command.

A lighting control system according to one aspect of the present invention includes: a plurality of lighting fixtures; and the lighting control device that controls the plurality of lighting fixtures.

### Advantageous Effects of Invention

The lighting control device and so on according to one or more aspects of the present invention are capable of identifying communication protocols even when two or more communication protocols are used in lighting fixtures.

### BRIEF DESCRIPTION OF DRAWINGS

FIG. 1 is a diagram illustrating an overview of setting a communication protocol for a conventional lighting control device.

FIG. 2 is a diagram illustrating an overview of switching communication protocols in a lighting control system according to an embodiment.

FIG. 3 is a block diagram of the lighting control system according to the embodiment.

FIG. 4 is a diagram illustrating an overview of a method of identifying two-way communication protocols in the lighting control system according to the embodiment.

FIG. 5 is a flowchart illustrating a process of a lighting control device according to the embodiment.

### DESCRIPTION OF EMBODIMENTS

Hereinafter, an embodiment will be described with reference to the drawings. Note that the embodiment described below shows a general or specific example. The numerical values, shapes, materials, structural elements, the arrangement and connection of the structural elements, etc. shown in the following embodiment are mere examples, and do not limit the scope of the present invention. Moreover, of the structural elements in the following embodiment, structural elements not recited in any one of the independent claims are described as optional structural elements.

Note that each diagram is a schematic diagram, and not necessarily a precise illustration. Note that throughout the figures, structural elements that are essentially the same share like reference signs, and duplicate description is omitted or simplified.

### Embodiment

### Comparative Example

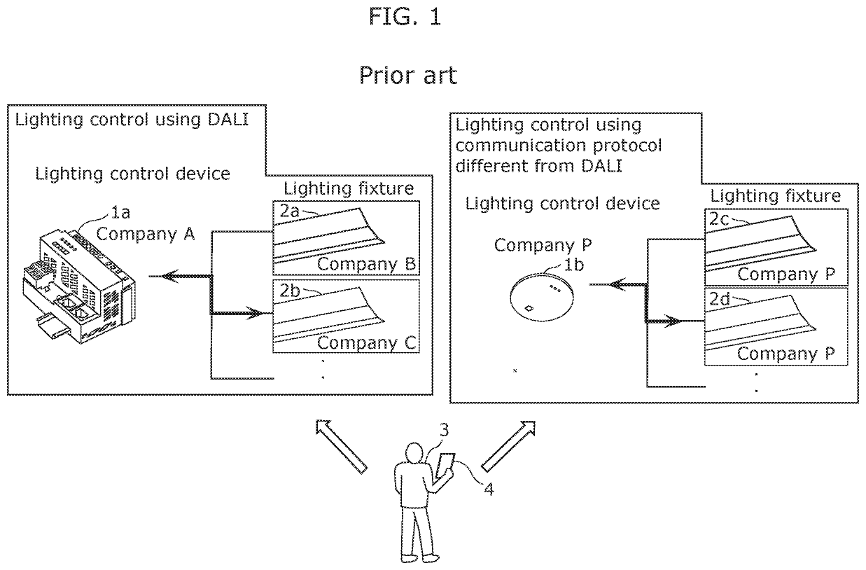

FIG. 1 is a diagram illustrating an overview of setting a communication protocol for conventional lighting control device 1a or 1b. Conventionally, when lighting fixtures 2a and 2b or lighting fixtures 2c and 2d are provided, for example, in an indoor location, lighting administrator 3 of a general contractor, design office, or the like have manually registered, in lighting control device 1a or 1b that supports one type of communication protocol, each of lighting fixtures 2a and 2b or each of lighting fixtures 2c and 2d that supports the same communication protocol as lighting control device 1a or 1b. For example, lighting administrator 3 registers lighting fixtures 2a and 2b that support, as a communication protocol, Digital Addressable Lighting Interface (DALI) (registered trademark) in lighting control device 1a of company A that supports DALI (registered trademark). For example, lighting fixture 2a may be manufactured by company B, and lighting fixture 2b may be manufactured by company C. The registration is performed by lighting administrator 3 operating terminal 4. Terminal 4 may be a tablet device, a smartphone, or a personal computer, for example.

After the registration of lighting fixtures 2a and 2b that support DALI (registered trademark) has been completed, lighting administrator 3 registers, in lighting control device 1b of company P that supports a communication protocol different from DALI (registered trademark), lighting fixtures 2c and 2d that support the communication protocol. For example, lighting fixture 2c and 2d may be manufactured by company P. The registration is performed by lighting administrator 3 operating terminal 4, as with the registration of lighting fixtures 2a and 2b that support DALI (registered trademark).

Note that the processing order of registration of lighting fixtures 2a and 2b that support DALI (registered trademark) and registration of lighting fixtures 2c and 2d that support a communication protocol different from DALI (registered trademark) may be reversed.

Here, a method of registering lighting fixtures 2a and 2b or lighting fixtures 2c and 2d that support one of the two types of communication protocols in lighting control device 1 by lighting administrator 3 has been described. However, the types of communication protocols are not limited to two types. Lighting administrator 3 may register three or more types of communication protocols in lighting control device 1a or 1b. When three or more types of communication protocols are registered, as with the case of two types of communication protocols, lighting administrator 3 registers, in lighting control device 1a or 1b through terminal 4, lighting fixtures 2a, 2b, 2c, and 2d. Here, lighting fixture 2a, 2b, 2c, and 2d, as a group, support each of the three or more types of communication protocols.

### [Switching Communication Protocols in Lighting Control System]

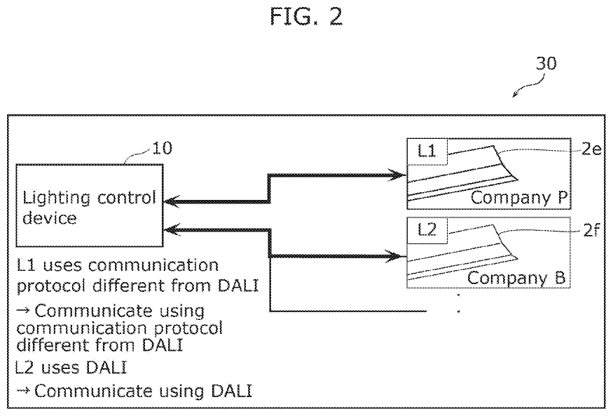

Next, switching communication protocols in lighting control system 30 according to an embodiment will be described. FIG. 2 is a diagram illustrating an overview of switching communication protocols in lighting control system 30 according to the embodiment.

Lighting control system 30 includes lighting control device 10 and a plurality of lighting fixtures including lighting fixtures 2e and 2f. First, lighting control device 10 simultaneously transmits a command that supports a communication protocol that is different from DALI (registered trademark) to each of the lighting fixtures including lighting fixtures 2e and 2f. Subsequently, lighting control device 10 records, lighting fixture 2f that has responded to the transmitted command in memory 13, which will be described later, as a lighting fixture that supports the communication protocol different from DALI (registered trademark).

Next, lighting control device 10 simultaneously transmits a command that supports DALI (registered trademark) to a plurality of lighting fixtures including lighting fixtures 2e and 2f. Subsequently, lighting control device 10 records lighting fixture 2e that has responded to the transmitted command in memory 13 as a lighting fixture that supports DALI (registered trademark).

As described above, a single lighting control device 10 according to the embodiment can support a plurality of communication protocols. Lighting control device 10 according to the embodiment switches the communication protocol to be applied to each lighting fixture 20 that supports one of the communication protocols.

### [Configuration of Lighting Control Device]

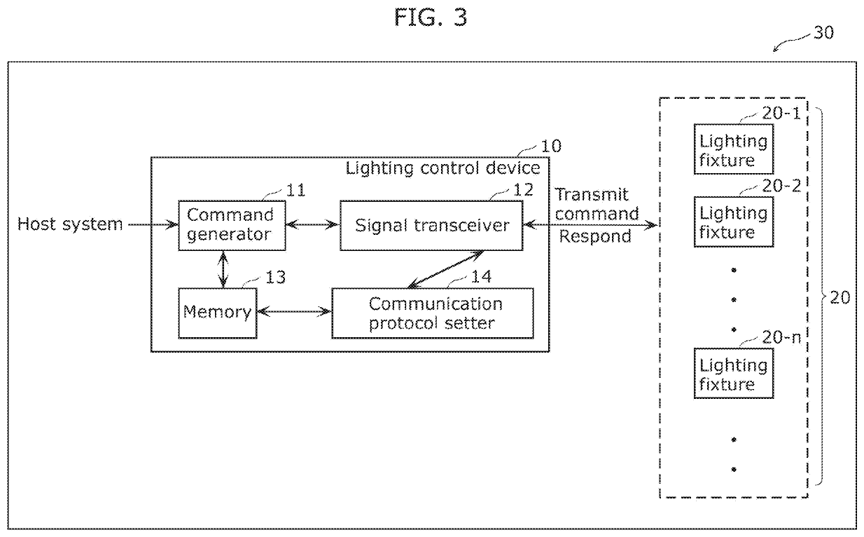

Next, a configuration of lighting control device 10 according to the embodiment will be described with reference to FIG. 3. FIG. 3 is a block diagram of lighting control device 10 according to the embodiment.

Lighting control device 10 includes command generator 11, signal transceiver 12, memory 13, and communication protocol setter 14.

Command generator 11 generates a command corresponding to each of various types of communication protocols and instructs to transmit the command, in response to an instruction from a host system. Here, the host system is, for example, a personal computer, a tablet device, or a smartphone for operating lighting control device 10. Moreover, the command generated by command generator 11 is, for example, a command that requests lighting fixtures 20-1 to 20-n to transmit a response. Moreover, command generator 11 may generate, for one or more lighting fixtures that support the communication protocol supported by the command, a command that requests, as a response, return of a signal indicating the unique ID, etc. of each of the one or more lighting fixtures, or a signal indicating the type of each of the one or more lighting fixtures. Moreover, command generator 11 may generate a command that requests return of a signal indicating a number indicating the manufacturer of each lighting fixture or a signal indicating a number indicating the product number of each lighting fixture.

Here, the various communication protocols supported by command generator 11 may be, for example, DALI (registered trademark), and a communication protocol that supports universal asynchronous receiver/transmitter (UART), which is different from DALI (registered trademark). Various communication protocols may also include a communication protocol that supports pulse width modulation (PWM).

Signal transceiver 12 transmits a command generated by command generator 11 to lighting fixtures 20-1 to 20-n. Signal transceiver 12 transmits a signal in accordance with the communication protocol set by communication protocol setter 14. Signal transceiver 12 may perform transmission in response to an instruction from the host system. Moreover, signal transceiver 12 broadcasts a command to each of lighting fixtures 20-1 to 20-n. In addition, signal transceiver 12 receives signals returned by lighting fixtures 20-1 to 20-n in response to the command transmitted by signal transceiver 12. Signal transceiver 12 may transmit the signals received from lighting fixtures 20-1 to 20-n to communication protocol setter 14. For example, signal transceiver 12 transmits a signal that supports a first communication protocol and a signal that supports a second communication protocol. One of the first communication protocol and the second communication protocol is DALI (registered trademark), and a remaining one of the first communication protocol and the second communication protocol is a communication protocol that supports UART and is different from DALI (registered trademark).

Communication protocol setter 14 determines which one of the communication protocols is to be used by signal transceiver 12. This determination is performed according to a lighting fixture to be controlled. Information about the communication protocol determined by communication protocol setter 14 to be used for communication is transmitted to signal transceiver 12. Communication protocol setter 14 may be configured to set three or more communication protocols. For example, the communication protocols that can be set by communication protocol setter 14 may be DALI (registered trademark), and a communication protocol that supports UART and is different from DALI (registered trademark).

Moreover, communication protocol setter 14 may set a communication protocol to be used, based on the signals received by signal transceiver 12 from lighting fixtures 20-1 to 20-n. Specifically, communication protocol setter 14 stores, in memory 13, for example, the ID, address, number indicating the manufacturer or product number of each of one or more lighting fixtures that have responded to the signal transmitted to each of lighting fixtures 20-1 to 20-n by signal transceiver 12 using the first communication protocol. This information is stored as information indicating the one or more lighting fixtures for which the first communication protocol should be used. Next, communication protocol setter 14 stores, in memory 13, for example, the ID, address, and number indicating the manufacturer, or product number of each of one or more lighting fixtures that have responded to the signal transmitted to each of lighting fixtures 20-1 to 20-n by signal transceiver 12 using the second communication protocol. This information is stored as information indicating one or more lighting fixtures for which the second communication protocol should be used.

Moreover, if lighting administrator 3 manually registers one or more lighting fixtures that have emitted light upon receipt of a command transmitted using a communication protocol that supports PWM, communication protocol setter 14 may store, in memory 13, for example, the ID, address, number indicating the manufacturer, or product number of each of the registered one or more lighting fixtures, as information indicating the one or more lighting fixtures for which the communication protocol that supports PWM should be used.

Specifically, command generator 11, signal transceiver 12, and communication protocol setter 14 are each achieved by a processor or a microcomputer, and a program to be executed by the processor or the microcomputer. Alternatively, command generator 11, signal transceiver 12, and communication protocol setter 14 are each achieved by a dedicated circuit.

Memory 13 stores, for example, the ID, address, number indicating the manufacturer, or product number of the one or more lighting fixtures that have responded to the signal transmitted to each of lighting fixtures 20-1 to 20-n by signal transceiver 12. Moreover, memory 13 stores information about the ID, address, number indicating the manufacturer, or product number of the one or more lighting fixtures, which is associated with the type of communication protocol to be used for the one or more lighting fixtures. The information stored in memory 13 may be transmitted to command generator 11 or communication protocol setter 14, or may be referred by command generator 11 or command generator 14. Memory 13 is achieved by, for example, read-only memory (ROM), random-access memory (RAM), semiconductor memory, or a hard disk drive (HDD).

For example, lighting fixtures 20-1 to 20-n are so-called ceiling lights that illuminate a room, and their dimming is controlled by controller 20. Note that the feature of each of lighting fixtures 20-1 to 20-n is not limited to a ceiling light having a rectangular shape in a plan view. Each of lighting fixtures 20-1 to 20-n may be, for example, a ceiling light, spotlight, base light, or downlight having a circular shape in a plan view. Lighting fixtures 20-1 to 20-n each emit light upon receipt of a signal from lighting control device 10.

Moreover, lighting fixtures 20-1 to 20-n each receive a command that requests a response from signal transceiver 12 of lighting control device 10 and transmit a response to signal transceiver 12 of lighting control device 10 in response to the command. Lighting fixtures 20-1 to 20-n are connected to lighting control device 10 through wired or wireless communication. Lighting fixtures 20-1 to 20-n may also be connected to one another through wired or wireless communication.

### [Registering Communication Protocol in Lighting Control System]

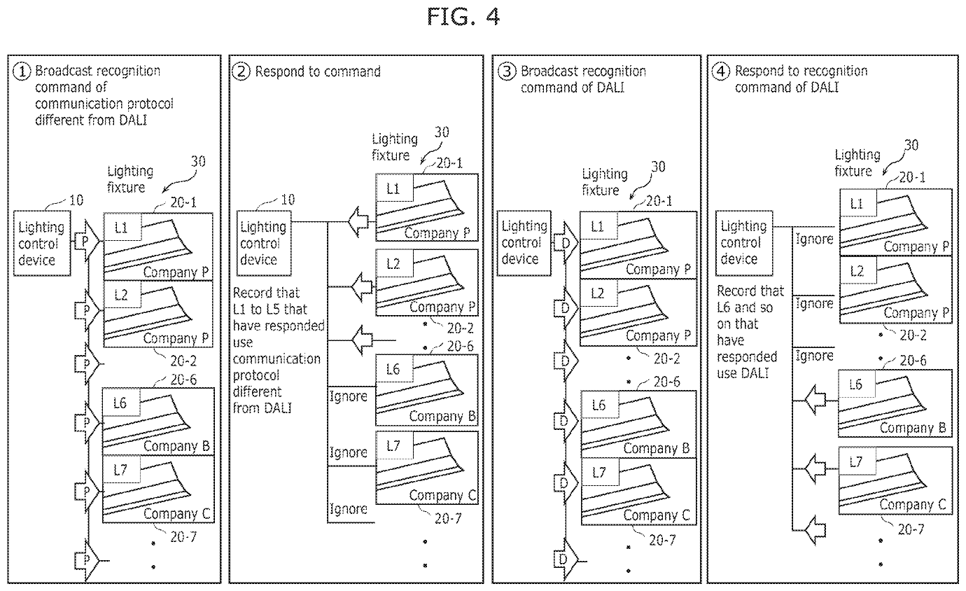

Next, registration of a communication protocol used in each lighting fixture will be described. FIG. 4 is a diagram illustrating an overview of a method of identifying two-way communication protocols in lighting control device 10 according to the embodiment. In FIG. 4, lighting fixtures 20-1 to 20-5 support the first communication protocol, and lighting fixtures 20-6 to 20-n support the second communication protocol.

First, lighting control device 10 simultaneously transmits (broadcasts), to each of lighting fixtures 20-1 to 20-n, a command that requests a response and supports a communication protocol that is different from DALI (registered trademark), which is an example of the first communication protocol. Among lighting fixtures 20-1 to 20-n that have received the command from lighting control device 10, one or more lighting fixtures that support the communication protocol different from DALI (registered trademark), which is supported by the command transmitted from lighting control device 10, each transmit a response to lighting control device 10. In the example illustrated in FIG. 4, among lighting fixtures 20-1 to 20-n that have received the command broadcasted from lighting control device 10, lighting fixtures 20-1, 20-2, 20-3, 20-4, and 20-5 each transmit a response to lighting control device 10. Here, lighting fixtures 20-1, 20-2, 20-3, 20-4, and 20-5 support the same communication protocol as the communication protocol supported by the broadcasted command. Lighting fixtures 20-6 to 20-n do not transmit a response to lighting control device 10 because lighting fixtures 20-6 to 20-n do not support the same communication protocol as the communication protocol supported by the broadcasted command.

Subsequently, lighting control device 10 records, in memory 13, lighting fixtures 20-1, 20-2, 20-3, 20-4, and 20-5 that have responded, as lighting fixtures that support the same communication protocol as the communication protocol supported by the broadcasted command.

Next, lighting control device 10 simultaneously transmits (broadcasts), to each of lighting fixtures 20-1 to 20-n, a command that requests a response and supports DALI (registered trademark), which is an example of the second communication protocol. Among lighting fixtures 20-1 to 20-n that have received the command supporting DALI from lighting control device 10, one or more lighting fixtures that support DALI (registered trademark), which is the communication protocol supported by the command broadcasted from lighting control device 10, each transmit a response to lighting control device 10. In the example illustrated in FIG. 4, among lighting fixtures 20-1 to 20-n that have received the command broadcasted from lighting control device 10, lighting fixtures 20-6 to 20-n each transmit a response to lighting control device 10. Here, lighting fixtures 20-6 to 20-n support DALI (registered trademark), which is the communication protocol supported by the broadcasted command. Lighting fixtures 20-1 to 20-5 do not transmit a response to lighting control device 10 because lighting fixtures 20-1 to 20-5 do not support DALI (registered trademark), which is the communication protocol supported by the broadcasted command.

Subsequently, lighting control device 10 records, in memory 13, lighting fixtures 20-6 to 20-n that have responded, as lighting fixtures that support DALI (registered trademark), which is a communication protocol supported by the broadcasted command.

Note that, here, lighting control device 10 determines whether each of the lighting fixtures support one of the two different communication protocols, associates information such as the ID or address of each lighting fixture with the type of the communication protocol supported by the corresponding lighting fixture, and stores the associated information. However, the types of communication protocols to be determined are not limited to two types. Three or more types of communication protocols may be determined.

Moreover, the communication protocol to be determined may include a communication protocol for one-way communication. In this case, a lighting fixture that supports a communication protocol for one-way communication cannot transmit a response to lighting control device 10. Therefore, in order to associate information such as the ID or address of a lighting fixture that supports a communication protocol for one-way communication, with the type of the communication protocol for one-way communication, the type of the communication protocol may be visually checked and manually set. Specifically, lighting control device 10 broadcasts a command for emitting light that supports a communication protocol for one-way communication, lighting administrator 3 visually checks the position, etc. of each of one or more lighting fixtures that emit light in response to the transmitted command. Lighting administrator 3 then sets, in communication protocol setter 14, the information such as the ID or address of each the one or more lighting fixtures that have been visually checked to emit light, as the ID or address, etc. of each of the one or more lighting fixtures that support the communication protocol for one-way communication. Here, communication protocol setter 14 associates the information such as the ID or address of each of the one or more lighting fixtures that support the communication protocol for one-way communication, with the type of the communication protocol for one-way communication, and stores the associated information.

Examples of the communication protocol for one-way communication include a communication protocol that supports PWM.

Moreover, if a single lighting fixture 20 supports a plurality of communication protocols, lighting control device 10 may associate the communication protocols with the single lighting fixture 20 and register the associated information.

### [Process of Lighting Control Device]

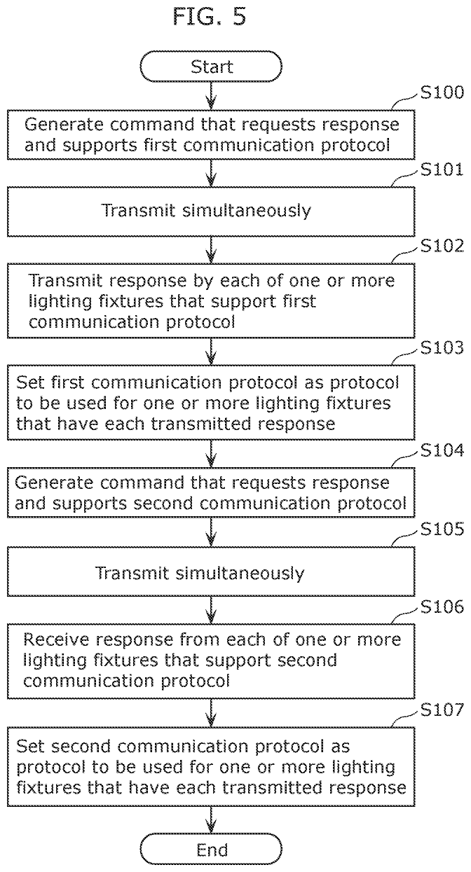

FIG. 5 is a flowchart illustrating a process of lighting control device 10 according to the embodiment.

First, command generator 11 generates a command that requests a response and supports the first communication protocol (step S100).

Next, signal transceiver 12 simultaneously transmits the command that requests a response and supports the first communication protocol to lighting fixtures 20-1 to 20-n (step S101).

Subsequently, each of one or more lighting fixtures that support the first communication protocol among lighting fixtures 20-1 to 20-n transmits a response (step S102).

Communication protocol setter 14 then sets the first communication protocol as the communication protocol to be used for the one or more lighting fixtures that have each transmitted a response to lighting control device 10 in step S102 (step S103). Communication protocol setter 14 associates information such as the ID or address of each of the one or more lighting fixtures that have transmitted a response to lighting control device 10 in step S102, with the information indicating the first communication protocol, and stores the associated information in memory 13.

Next, command generator 11 generates a command that requests a response and supports the second communication protocol (step S104).

Signal transceiver 12 then simultaneously transmits the command that requests a response and supports the second communication protocol to lighting fixtures 20-1 to 20-n (step S105).

Subsequently, signal transceiver 12 receives a response from each of one or more lighting fixtures that support the second communication protocol among lighting fixtures 20-1 to 20-n (step S106).

Communication protocol setter 14 then sets the second communication protocol as a communication protocol to be used for the one or more lighting fixtures that have each transmitted a response to lighting control device 10 in step S106 (step S107). Communication protocol setter 14 associates information such as the ID or address of each of the one or more lighting fixtures that have transmitted a response to lighting control device 10 in step S106, with the information indicating the second communication protocol, and stores the associated information in memory 13.

Note that S104 to S107 may be omitted.

### [Effects, etc.]

Lighting control device 10 is a lighting control device that controls a plurality of lighting fixtures. The lighting control device includes: command generator 11 that generates one or more commands for controlling the plurality of lighting fixtures 20; signal transceiver 12 that communicates with the plurality of lighting fixtures 20; and communication protocol setter 14 that sets which one of two or more types of communication protocols is to be used, the two or more types of communication protocols including a first communication protocol. Signal transceiver 12 simultaneously transmits, using the first communication protocol, a first command to each of the plurality of lighting fixtures 20, the first command being included in the one or more commands and requesting a response, and communication protocol setter 14 sets the first communication protocol as the communication protocol to be used for one or more of the plurality of lighting fixtures 20 that have responded to the first command.

This allows lighting control device 10 to identify the communication protocol supported by each of lighting fixtures 20, associate the communication protocol with each of lighting fixtures 20, and store information about the communication protocol supported by each of lighting fixtures 20.

In lighting control device 10, the two or more types of communication protocols include a second communication protocol that is different from the first communication protocol, after transmitting the first command, signal transceiver 12 simultaneously transmits, using the second communication protocol, a second command to each of the plurality of lighting fixtures 20, the second command being included in the one or more commands and requesting a response, and communication protocol setter 14 sets the second communication protocol as a communication protocol to be used for one or more of the plurality of lighting fixtures 20 that have responded to the second command.

This allows lighting control device 10 to identify which one of the two communication protocols is supported by each of lighting fixtures 20, associate one of the two communication protocols each of lighting fixtures 20, and store the information about the communication protocol supported by each of lighting fixtures 20.

Lighting control device 10 further includes memory 13. The first command is included in the one or more commands and requests return of a signal indicating a first number indicating a manufacturer of each of the plurality of lighting fixtures 20 or a signal indicating a second number indicating a product number of each of the plurality of lighting fixtures 20, and communication protocol setter 14 further stores, in memory 13, the first number or the second number that has been returned.

This allows lighting control device 10 to associate information indicating the manufacturer or product number of each of lighting fixtures 20 with information about the communication protocol supported by each of lighting fixtures 20, and store the associated information.

In lighting control device 10, one of the first communication protocol and the second communication protocol is Digital Addressable Lighting Interface (DALI) (registered trademark), and a remaining one of the first communication protocol and the second communication protocol is a communication protocol that supports a universal asynchronous receiver/transmitter (UART) and is different from DALI (registered trademark).

This allows lighting control device 10 to distinguish between a communication protocol that supports DALI (registered trademark) and a communication protocol that supports UART, which is different from DALI (registered trademark).

Lighting control system 30 includes: a plurality of lighting fixtures 20; and lighting control device 10 that controls the plurality of lighting fixtures 20.

This allows lighting control system 30 to provide the same effect as the above lighting control device 10.

### [Others]

An embodiment has been described above, but the present invention is not limited to the embodiment described above.

For example, in the embodiment described above, a processing operation performed by a particular processor may be performed by a different processor. Moreover, the order of processing operations may be changed, and processing operations may be performed in parallel.

In addition, in the embodiment described above, each structural element may be achieved by executing an appropriate software program for the structural element. Each structural element may be achieved by a program executor, such as a CPU or a processor, reading and executing a software program recorded on a recording medium, such as a hard disk or semiconductor memory.

Moreover, each structural element may be achieved by hardware. For example, each structural element may be a circuit (or integrated circuit). These circuits may constitute one circuit as a whole, or each circuit may be a separate circuit. Each of these circuits may be a general-purpose circuit or a dedicated circuit.

Moreover, the general or specific aspects of the present invention may be achieved by a system, a device, a method, an integrated circuit, a computer program, or a computer-readable recording medium such as a CD-ROM. Moreover, the general or specific aspects of the present invention may be achieved by any combination of systems, devices, methods, integrated circuits, computer programs, and recording media.

For example, the present invention may be achieved as a program for causing a computer to execute a lighting control method (a method of setting a communication protocol) performed by the lighting control device according to the above embodiment. The present invention may be achieved as a non-transitory computer-readable recording medium having such a program recorded thereon.

Note that such a program includes an application program for operating a general-purpose mobile terminal as the lighting control device according to the above embodiment.

Other embodiments implemented through various changes and modifications conceived by a person of ordinary skill in the art based on the above embodiments or through a combination of the structural elements in the above embodiments in any manner that does not depart from the scope of the present invention may be included in the scope in an aspect or aspects according to the present invention.

1. A lighting control device that controls a plurality of lighting fixtures, the lighting control device comprising:
a command generator that generates one or more commands for controlling the plurality of lighting fixtures;
a signal transceiver that communicates with the plurality of lighting fixtures; and
a communication protocol setter that sets which one of two or more types of communication protocols is to be used, the two or more types of communication protocols including a first communication protocol,
wherein the signal transceiver simultaneously transmits, using the first communication protocol, a first command to each of the plurality of lighting fixtures, the first command being included in the one or more commands and requesting a response, and
the communication protocol setter sets the first communication protocol as the communication protocol to be used for one or more of the plurality of lighting fixtures that have responded to the first command.

2. The lighting control device according to claim 1,
wherein the two or more types of communication protocols include a second communication protocol that is different from the first communication protocol,
after transmitting the first command, the signal transceiver simultaneously transmits, using the second communication protocol, a second command to each of the plurality of lighting fixtures, the second command being included in the one or more commands and requesting a response, and
the communication protocol setter sets the second communication protocol as a communication protocol to be used for one or more of the plurality of lighting fixtures that have responded to the second command.

3. The lighting control device according to claim 1, further comprising:
memory,
wherein the first command is included in the one or more commands and requests return of a signal indicating a first number indicating a manufacturer of each of the plurality of lighting fixtures or a signal indicating a second number indicating a product number of each of the plurality of lighting fixtures, and
the communication protocol setter further stores, in the memory, the first number or the second number that has been returned.

4. The lighting control device according to claim 2,
wherein one of the first communication protocol and the second communication protocol is Digital Addressable Lighting Interface (DALI) (registered trademark), and
a remaining one of the first communication protocol and the second communication protocol is a communication protocol that supports a universal asynchronous receiver/transmitter (UART) and is different from DALI (registered trademark).

5. A lighting control system comprising:
a plurality of lighting fixtures; and
the lighting control device according to claim 1 that controls the plurality of lighting fixtures.
